(19) United States
(12) Patent Application Publication
(10) Pub. No.: US 2016/0055691 A1
(43) Pub. Date: Feb. 25, 2016

(54) SMART KEY CONTROL SYSTEM AND METHOD FOR VEHICLE

(71) Applicant: HYUNDAI MOTOR COMPANY, Seoul (KR)

(72) Inventor: Yongseok JEONG, Yongin-si (KR)

(21) Appl. No.: 14/558,380

(22) Filed: Dec. 2, 2014

(30) Foreign Application Priority Data
Aug. 19, 2014 (KR) 10-2014-0107570

(51) Int. Cl. G07C 9/00

(52) U.S. Cl. CPC G07C 9/00007

(57) ABSTRACT

A method for controlling a remote control key of a vehicle which includes the remote control key for remotely controlling control objects of the vehicle. The method includes receiving an order for whether to lock or unlock the remote control key and locking the remote control key if the received order is for locking the remote control key.

### CROSS-REFERENCE TO RELATED APPLICATION

This application claims the benefit of priority to Korean Patent Application No. 10-2014-0107570 filed in the Korean Intellectual Property Office on Aug. 19, 2014, the entire contents of which are incorporated herein by reference.

### TECHNICAL FIELD

The present disclosure relates to a smart key control system and method for a vehicle. More particularly, the present disclosure relates to a smart key control system and method for a vehicle which prevent a use of a lost or stolen remote control key.

### BACKGROUND

With the development of wireless communication, various devices related to wireless communication have been developed and mounted on vehicles. For example, an automotive remote control key controls a door, a trunk, and a start motor of a vehicle through wireless communication.

Such an automotive remote control key is called a smart key, a fob key, or a remote start key. Accordingly, the automotive remote control key is defined herein as including all of the smart key, the fob key, and the remote start key that use wireless communication.

Such an automotive remove control key remotely opens or closes the vehicle door, and locates the vehicle by turning on/off lamps on the vehicle at a distance. Further, the automotive remove control key opens or closes the vehicle door when a user presses a button on door handles.

Accordingly, the automotive remove control key improves user convenience, but if the key is lost, the vehicle may get stolen.

The above information disclosed in this Background section is only for enhancement of understanding of the background of the disclosure, and therefore, it may contain information that does not form the prior art that is already known in this country to a person of ordinary skill in the art.

### SUMMARY

The present disclosure has been made in an effort to provide a control system and method of a remove control key for a vehicle having advantages of preventing a vehicle from being stolen, when the remote control key is lost.

According to an exemplary embodiment of the present inventive concept, a method for controlling a remote control key of a vehicle, which includes the remote control key for remotely controlling control objects of the vehicle. The method may include receiving an order for whether to lock or unlock the remote control key and locking the remote control key if the received order is locking the remote control key.

The step of locking the remote control key may include searching a registered remote control key. Whether the registered remote control key is found is determined. Other remote control keys except for the found registered remote control key are locked.

An identification (ID) number of the registered remote control key may be searched.

The step of unlocking the remote control key may include searching the registered remote control key. Whether the registered remote control key is found is determined. A found remote control key is unlocked when the registered remote control key is found.

According to another exemplary embodiment of the present inventive concept, a system for controlling a remote control key of a vehicle includes the remote control key that remotely controls control objects of the vehicle and keeps an ID number. A controller is disposed in the vehicle and configured to lo determine whether there is the remote control key in the vehicle on the basis of the ID number of the remote control key and to lock or unlock the remote control key.

The remote control key may include a memory for storing the ID number. A remote control key transceiver is configured to transmit the ID number in the memory.

The controller may include a control module transceiver configured to receive the ID number transmitted from the remote control key transceiver. A setter is configured to lock or unlock the found remote control key by comparing the ID number received through the control module transceiver with a registered ID number.

The controller may further include an input configured to receive a locking order or an unlocking order from a driver operating the input.

When the locking order is inputted through the input and a remote control key having an ID number identical with the registered ID number is found, the setter may lock other remote control keys except for the searched remote control key.

When the unlocking order is inputted through the input and a remote control key having an ID number identical with the registered ID number is found, the setter may unlock the found remote control key.

According to the system for controlling a remote control key for a vehicle of an exemplary embodiment of the present inventive concept, when a remote control key is lost, the remote control key can be locked, so it is possible to minimize the possibility of steal of a vehicle.

### BRIEF DESCRIPTION OF THE DRAWINGS

The drawings are provided for reference in describing exemplary embodiments of the present inventive concept, and the spirit of the present disclosure should not be construed only by the accompanying drawings.

FIG. 1 is a diagram showing the configuration of a system for controlling a remote control key for a vehicle according to an exemplary embodiment of the present inventive concept.

FIG. 2 is a flowchart illustrating a method of controlling a remote control key for a vehicle according to an exemplary embodiment of the present inventive concept.

FIG. 3 is a flowchart illustrating a way of locking a remote control key according to an exemplary embodiment of the present inventive concept.

FIG. 4 is a flowchart illustrating a way of unlocking the remote control key according to an exemplary embodiment of the present inventive concept.

### DETAILED DESCRIPTION

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the present inventive concept.

The parts not related to the description of the exemplary embodiments are not shown to make the description clear and like reference numerals designate like elements throughout the specification.

The sizes and thicknesses of the configurations shown in the drawings are provided selectively for the convenience of description, such that the present inventive concept is not limited to those shown in the drawings and the thicknesses are exaggerated to make some parts and regions clear.

Hereinafter, a control system of a remote control key for a vehicle according to an exemplary embodiment of the present inventive concept will be described in detail with reference to the accompanying drawings.

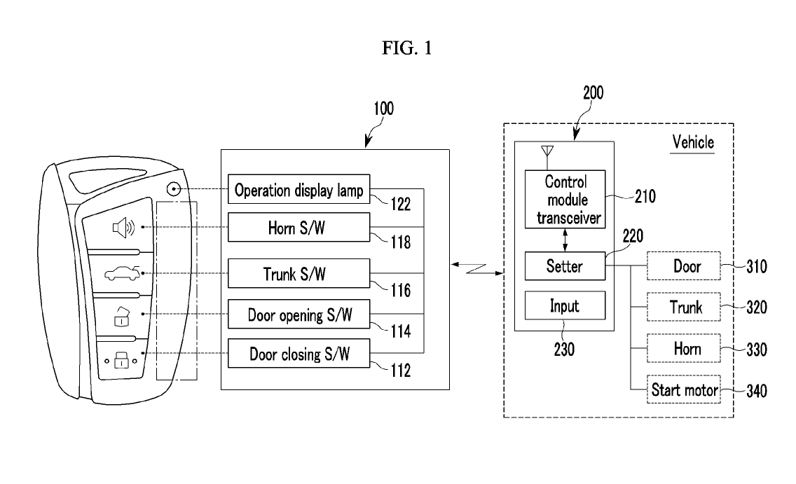

FIG. 1 is a diagram showing a control system of a remote control key for a vehicle according to an exemplary embodiment of the present inventive concept.

As shown in FIG. 1, a system for controlling a remote control key for a vehicle according to an exemplary embodiment of the present inventive concept includes a remote control key 100 that remotely controls predetermined control objects of the vehicle and keeps an ID number and a controller 200 that is mounted on the vehicle and locks or unlocks the remote control key 100 by determining whether the remote control key 100 is in the vehicle on the basis of the ID number of the remote control key 100.

A driver having the remote control key 100 can lock and unlock doors by operating a door lock switch and a door unlock switch button, respectively.

Further, the driver having the remote control key 100 can locate his/her vehicle by hearing a sound, by operating a vehicle location alarm switch so that a horn in the vehicle operates.

Further, a driver having the remote control key 100 can lock or unlock a door by pressing a door open button on the door handle in a vehicle.

Locking the remote control key 100 means that the functions described above cannot be used.

On the contrary, unlocking the remote control key 100 means that the functions described above can be used.

The remote control key 100 includes a memory that keeps the ID number and a wireless remote control key transceiver that transmits the ID number in the memory 160.

The controller 200 includes a wireless control module transceiver that receives the ID number transmitted from the wireless remote control key transceiver and a setter 220 that locks or unlocks the found remote control key 100 by comparing a registered ID number with an ID number received from the wireless remote control key transceiver.

The controller 200 may be a module corresponding to a body control module (BCM).

Alternatively, the controller 200 may be combined with a BCM and another controller 200, for example, an engine control module (ECU) that controls an engine.

The controller 200 may be implemented by one or more processors operated by a predetermined program, in which the predetermined program is set to perform steps of a method of controlling the remote control key 100 for a vehicle according to an exemplary embodiment of the present inventive concept.

The controller 200 may further include an input 230 that receives a locking order or an unlocking order from a driver operating the input 230. The input 230 may have a configuration corresponding to an user setting mode (USM) of the cluster in the vehicle. Alternatively, the input 230 may have a configuration corresponding to the input 230 of an audio video navigation (AVN) in the vehicle.

When a locking order is inputted through the input 230 and the remote control key 100 having an ID number identical with the registered ID number is found, the setter 220 can lock other remote control keys 100 except for the found remote control key 100.

When the unlocking order is inputted through the input 230 and the remote control key 100 having the ID number identical with the registered ID number is found, the setter 220 can unlock the found remote control key 100.

Hereinafter, a method of controlling the remote control key for a vehicle according to an exemplary embodiment of the present inventive concept is described in detail.

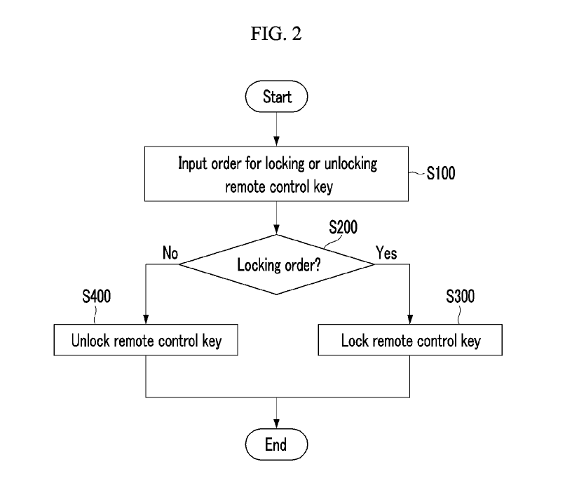

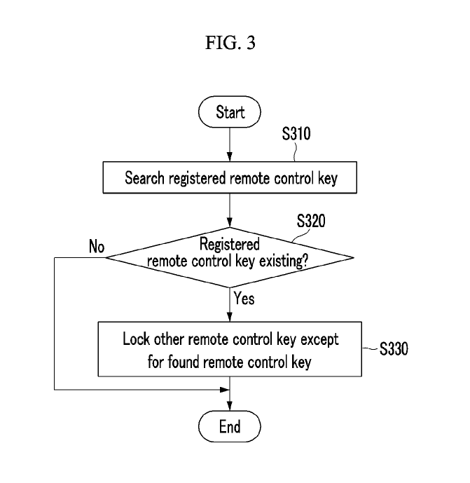

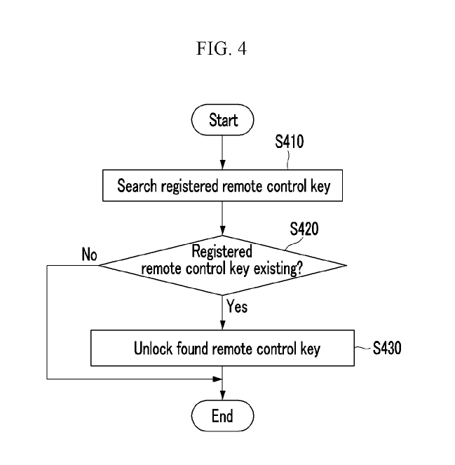

FIG. 2 is a flowchart illustrating a control method of a remote control key for a vehicle according to an exemplary embodiment of the present inventive concept. FIG. 3 is a flowchart illustrating a method of locking a remote control key according to an exemplary embodiment of the present inventive concept. FIG. 4 is a flowchart illustrating a method of unlocking the remote control key according to an exemplary embodiment of the present inventive concept.

A driver inputs an order for locking the remote control key 100 or an order for unlocking the remote control key 100 through the input 230 (S100).

When an order inputted through the input 230 is the order for locking the remote control key 100 (S200), the setter 220 locks the remote control key 100 (S300).

The way of locking the remote control key 100 is as follows.

As shown in FIG. 3, when an order for locking a remote control key 100 is inputted through the input 230, the setter 220 searches whether the remote control key 100 registered on the setter 220 is in a vehicle (S310).

The setter 220 determines whether the remote control key 100 registered on the setter 220 is in the vehicle by searching the remote control key 100 (S320).

The setter 220 compares the ID number registered on the setter 220 with the ID number of the remote control key 100 which is transmitted through the remote control key transceiver 150, and when an ID number identical with the ID number registered on the setter 220 is found, the setter 220 can determine whether there is the remote control key 100 in the vehicle.

That is, when the ID number registered on the setter 220 was found, it determines that the remote control key 100 having the ID number was found. Further, when the ID number registered on the setter 220 is not found, it determines that a remote control key 100 having the ID number was not found.

The method of searching the remote control key 100 searches whether there is the remote control key 100, using the ID number transmitted between the remote control key transceiver 150 and the control module transceiver 210.

The transmission between the remote control key 100 and the controller 200 can be achieved in various ways. However, such data transmission is general in this field, so it is not described in detail herein.

When there is the remote control key 100 registered on the setter 220 in the vehicle, other remote control keys 100 except for the remote control key 100 are locked (S330).

That is, when a remote control key 100 registered on the setter 220 was not found, it is determined that the remote control key 100 is lost and the remote control key 100 is locked. Accordingly, it is possible to prevent the vehicle from being stolen due to the lost key.

When all of the remote control keys 100 registered on the setter 220 were found, it is determined there is no remote control key 100 lost and the process of locking a remote control key 100 is ended.

When an order for unlocking a remote control key 100 is inputted in the step S200, the setter 220 unlocks the remote control key 100 (S400).

The way of unlocking a remote control key 100 is as follows.

As shown in FIG. 4, when an order for unlocking the remote control key 100 is inputted through the input 230, the setter 220 searches whether the remote control key 100 registered on the setter 220 is in a vehicle (S410).

The setter 220 determines whether the remote control key 100 registered on the setter 220 is in the vehicle by searching the remote control key 100 (S420).

When a remote control key 100 registered on the setter 220 is in a vehicle, the found remote control key 100 is unlocked (S430).

That is, when a remote control key 100 registered on the setter 220 was found, it is determined that the remote control key 100 was found and the remote control key 100 is unlocked. Accordingly, various functions obtained by the remote control key 100 are activated.

When the remote control key 100 registered on the setter 220 was not found, the process of unlocking the remote control key 100 is ended.

While this inventive concept has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for controlling a remote control key of a vehicle including the remote control key that remotely controls control objects of the vehicle, the method comprising steps of:
receiving an order for whether to lock or unlock the remote control key; and
locking the remote control key if the received order is locking the remote control key.

2. The method of claim 1, after receiving the order, further comprising a step of:
unlocking the remote control key if the received order is unlocking the remote control key.

3. The method of claim 1, wherein the step of locking the remote control key includes steps of:
searching a registered remote control key;
determining whether the registered remote control key is found; and
locking other remote control keys except for the found registered remote control key.

4. The method of claim 3, wherein the step of searching the registered remote control key includes a step of:
searching an identification (ID) number of the registered remote control key.

5. The method of claim 2, wherein the step of unlocking the remote control key includes steps of:
searching a registered remote control key;
determining whether the registered remote control key is found; and
unlocking the found registered remote control key.

6. The method of claim 4, wherein the step of searching the registered remote control key includes a step of:
searching an ID number of the registered remote control key.

7. A system for controlling a remote control key of a vehicle, the system comprising:
the remote control key that remotely controls control objects of the vehicle and stores an ID number; and
a controller provided in the vehicle, the controller configured to determine whether there is the remote control key in the vehicle on the basis of the ID number of the remote control key and to lock or unlock the remote control key.

8. The system of claim 7, wherein the remote control key includes:
a memory for storing the ID number; and
a remote control key transceiver configured to transmit the ID number in the memory.

9. The system of claim 8, wherein the controller includes:
a control module transceiver configured to receive the ID number transmitted from the remote control key transceiver; and
a setter configured to lock or unlock the found remote control key by comparing the ID number received through the control module transceiver with a registered ID number.

10. The system of claim 9, wherein the controller further includes:
an input configured to receive a locking order or an unlocking order from a driver operating the input.

11. The system of claim 10, wherein:
when the locking order is inputted through the input and a remote control key having an ID number identical with the registered ID number is found, the setter locks other remote control keys except for the found remote control key.

12. The system of claim 10, wherein when the unlocking order is inputted through the input and a remote control key having an ID number identical with the registered ID number is found, the setter unlocks the found remote control key.
